(19) United States
(12) Patent Application Publication
(10) Pub. No.: US 2008/0142448 A1
(43) Pub. Date: Jun. 19, 2008

(54) Treatment of metal-containing liquids

(76) Inventors: David T. Hobbs, N. Augusta, SC (US); John C. Wataha, Martinez, GA (US); Jill Lewis, Martinez, GA (US); Regina L.W. Messer, Martinez, GA (US)

Correspondence Address: MCNAIR LAW FIRM, P.A., P.O. BOX 10827, GREENVILLE, SC, 29603-0827, US

(21) Appl. No.: 11/638,843

(22) Filed: Dec. 14, 2006

(51) Int. Cl. C02F 1/42

(52) U.S. Cl. 210/688

(57) ABSTRACT

A method for removing metal ions from a liquid having a wide range of pH levels by treating the liquid with a titanate sorbent, preferably monosodium titanate or amorphous peroxotitanate. In one embodiment, wastewater contaminated with mercury or cadmium may be purified.

### FEDERALLY SPONSORED RESEARCH

The U.S. Government has rights in this invention pursuant to contract number DE-ACO9-96SR18500 between the U.S. Department of Energy and Washington Savannah River Company LLC.

### FIELD OF THE INVENTION

This invention relates to the treatment of liquids with an inorganic sorbent to remove metal ions that may be contained within the liquids. Particularly, the invention relates to the removal of a wide range of metals from aqueous media by sorption onto a titanate material, specifically, monosodium titanate (MST) or amorphous peroxotitanate (APT).

### BACKGROUND

Current treatments for removing metals from water usually employ metal ion exchangers which use organic-based materials. These materials exhibit susceptibility to chemical decomposition and degradation which in time can produce undesirable odors and by-products. Inorganic materials such as MST and APT are odorless, are effective, and are chemically inert over a wide pH range. Thus, MST and APT can be used in ecosystems for cleanup where organics are not desirable.

MST and APT can be produced in fine powders that effectively remove strontium, plutonium, neptunium, and other trace elements from highly alkaline and high ionic strength solutions. MST strongly absorbs or ion exchanges with a number of metallic species in a variety of aqueous media. As an example of some of the prior uses of MST reference is made to U.S. Pat. No. 6,268,307 entitled “Titania Bound Sodium Titanate Ion Exchanger” which issued on Jul. 31, 2001 to DeFilippi et al. and to U.S. Pat. No. 6,517,788 entitled “Method and Device for Separating Caesium, Strontium and Transuranium Elements Contained in Sodium Waste” which issued on Feb. 11, 2003 to Debreuille et al. In addition, more recent work with MST is reported in a paper entitled “Engineering Monosodium Titanate for Adsorption Column Processes” by C. A. Nash et al. in the WM '05 Conference of Feb. 27, 2005.

A new family of titanate materials is represented by amorphous peroxotitanate or APT. This family of titanate materials has shown even better performance than MST in separating strontium and actinides from alkaline waste solutions. Incorporated herein by reference are the following articles which further describe APT: “Development of Improved Sorbents for Radiochemical Separations at the Savannah River Site,” Hobbs, D. T.' Nyman, M. D.; Tripathi, A.; Medvedev, D.; Clearfield, A.; Proceedings of the Waste Management Conference, Tuscon, Ariz., Feb. 27-Mar. 3, 2005, “Development of an Improved Sodium Titanate for the Pretreatment of Nuclear Waste at the Savannah River Site,” Hobbs, D. T.; NYMAN, M. D.; Poirier, M. R.; Barnes, M. J.; Stallings, M. E.; Proceedings of the Symposium on Waste Management, Tuscon, Ariz., Feb. 26-Mar. 2, 2006, and “A Family of Peroxotitanate Materials Tailored for Optimal Strontium and Actinide Sorption,” Nyman, May.; Hobbs, David T.; Chemistry of Materials, published on Web Nov. 18, 2006.

While the prior art uses of MST as mentioned above have focused generally on the separation of radionuclides from waste solutions such as those produced in processing spent nuclear fuel at high pH levels, the potential uses of the affinity of MST or APT for metals in liquids of lower pH levels, particularly in near neutral ranges is yet to be developed and, accordingly, it is one object of the present invention to provide such uses.

Furthermore, it is another object of the present invention to provide a method for removing metal ions from liquids using inert inorganic substances such as MST and APT. These novel uses of MST and APT are described below.

### SUMMARY OF THE INVENTION

As used herein the term “titanate sorbent” includes MST and APT but may include other titanate materials having affinity for metal ions in solution.

In one aspect, the present invention is a method of treating liquids that have metals or metal ions therein comprising the steps of providing a filter material or membrane comprising or embedded with a titanate sorbent; providing a liquid containing metal; and, passing said liquid through said membrane or material whereby the titanate sorbent adsorbs the metal from the liquid. Examples of specific metals include, but are not limited to cadmium, mercury, nickel, gold, plutonium, uranium, neptunium, protactinium, americium or curium. In general, all metals except the alkali metals are included.

In another aspect, the treatment process employs a column containing a bed of titanate sorbent through which a metal-containing liquid is passed and the metal removed.

In yet another aspect, the liquid is an aqueous medium such as wastewater and the metals are contaminants to be removed.

In a further aspect, APT is used alone as the titanate sorbent; in an additional aspect MST is used alone; and, in another aspect APT and MST are used in combination. In each instance the sorbent or sorbent combination is selected for the most effective removal of the metal from the liquid.

In still one more aspect, the present invention is a batch process in which a metal-containing liquid is placed in a container or tank and MST, APT or a combination of them is mixed into the liquid with or without subsequent agitation, held, and then as the liquid is emptied from the tank it is filtered to remove the titanate sorbent. While the invention may uniquely and effectively remove metal in solutions of near neutral pH it is effective in a wide range. Thus, liquids having a pH level in the range of 2 to 14 may be treated by the process of this invention.

### DESCRIPTION OF THE DRAWINGS

In the drawings which are attached hereto and made a part of this disclosure by way of illustration and not limitation;

FIG. 1 is a schematic-representation of a filter cartridge system embodying the present invention; and,

FIG. 2 is a schematic representation of an adsorbent bed system embodying the present invention.

### DETAILED DESCRIPTION

Two titanate sorbents that have been discovered to be useful in removing metals or metal ions from liquid at mid-range or near neutral pH levels are monosodium titanate (MST) and amorphous peroxotitanate (APT). MST is a white, inorganic, amorphous, poorly crystalline sodium titanate sorbent material that exhibits high selectivity for sorbing strontium and actinide radioisotopes in the presence of strongly alkaline and high sodium-containing solutions. Its baseline chemical composition is:

HNaTi₂O₅xH₂O where x˜2−4

The peroxotitanate is also amorphous and can be prepared with varying amounts of sodium, peroxide and water resulting in a general formula of the type:

HᵥNa_{w}Ti₂O₅(xH₂O) [yH_{z}O₂] where v+w=2 and z=O to 2

The quantity of sorbent to use will depend upon the concentration of metal(s) to be removed and the quantity of liquid to be treated, The sorbent charge in the treatment system must be sufficient to continue operation without frequent shutdown to recharge. These parameters are readily determined by one skilled in the art.

A preferred embodiment and best mode of the invention is a batch process, whereby the liquid containing the metal ions is placed or poured into a container or tank and a charge of titanate absorbent is added and mixed into the liquid. Titanate sorbents have demonstrated a high affinity for cadmium, mercury, gold, and strontium by removing these metal contaminants from liquids. The quantity of sorbent and the time required for agitation are readily determined by one skilled in the art. The preferred method of separating the sorbent particles from the liquid after the particles have become loaded with metal is by filtration. The sorbent particles can also be separated by centrifugation.

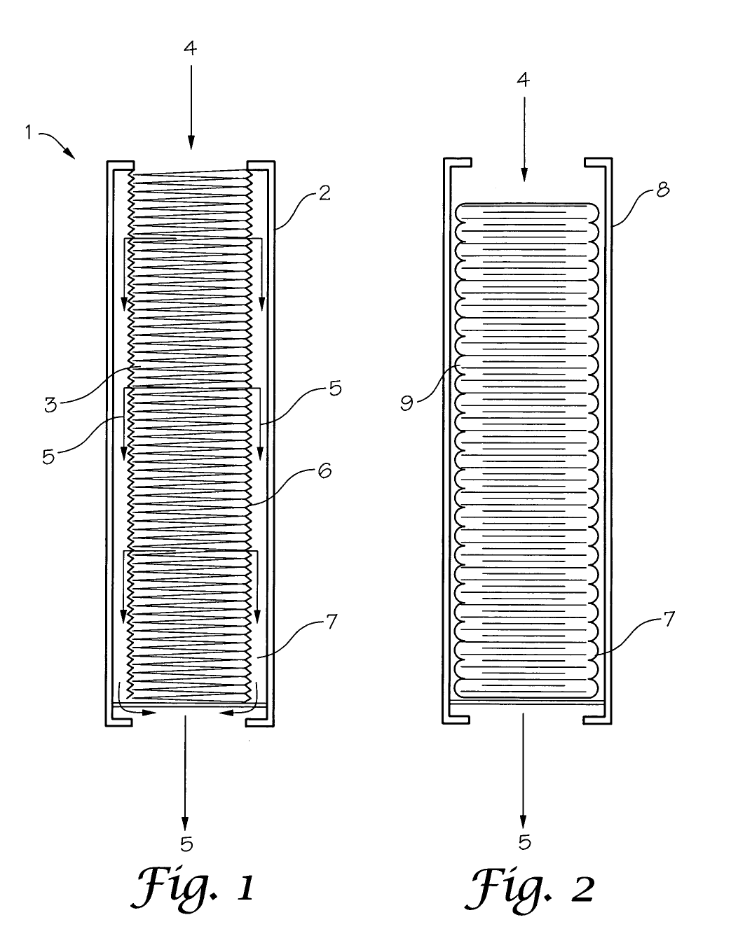

Turning first to FIG. 1, another embodiment of the invention, which is particularly suitable for small and intermediate quantities of liquid wastes, and which comprises a filter system will be described. Filter system 1 is shown comprising filter cylindrical housing 2 in which filter cartridge 3 is centrally positioned. Metal contaminated liquids 4 enter the cartridge 3 at the upper end thereof, passes through the peripheral membrane 6 of the cartridge; emerge as decontaminated liquid 5 in the annular region 6 of the filter and exits at the lower end of the housing 2. In general, the pH of the liquid may be adjusted, if necessary for efficiency, by adding either base or acid to the water.

Cartridge 3 comprises a filter membrane or material containing the titanate adsorbent of the invention. Dissolved metal ions in the liquid contact and are adsorbed onto the titanate sorbent thus removing metal ions from the liquid. The filter membrane material is prepared by embedding or entrapping the adsorbent particles in powder form into an inert porous matrix. Further, APT and MST may be combined in the matrix depending on their respective efficiency for the metals being removed.

This filter system is especially efficient in removing mercury and cadmium from wastewater systems.

The above filter system described may also work in reverse whereby the wastewater is first introduced into the annular region 7 and then passes radially inward through membrane 6 to be collected and removed. In addition, filters may be arranged in tandem with the exit liquid from one filter being the inlet liquid for a second filter. This tandem arrangement can be repeated as necessary.

Membrane 6 may comprise any appropriate carrier material onto which or into which the titanate sorbent may be embedded. For example, the membrane material may be a fibrous cellulosic material or polymeric material constructed as known to those skilled in the art of filter design and fabrication. Carrier matrices preferably allow significant surface area of the sorbent titanate to be exposed to the metal-containing liquid for highest efficiency.

Turning now to FIG. 2, an alternate embodiment which is preferred for treating relatively large waste streams and which comprises an adsorbent bed system will be described. Column 8 is packed with adsorbent material 9 through which contaminated wastewater 4 that enters the upper end of column 8 passes through bed 9 and emerges as decontaminated water 5 at the lower end of the column. During passage of the wastewater through the bed the metal ions in the wastewater are adsorbed by the titanate sorbent and, consequently, are removed from the liquid. The liquid may now be discharged or recovered for further use.

MST and APT are most conveniently and usefully prepared in fine powder form. For packed bed arrangements, the powder form can be incorporated into an inert matrix to form larger particles that are suitable for use in packed bed system. MST has been incorporated into porous media such as alumina or silica and spherical beads in a hydrous titanium oxide matrix have been produced. The sorbent particles are held in place within the column by loosely parking the particles between layers of fine meshed retaining screens.

The titanate sorbents that have proven to be effective in removing metals from aqueous media have other uses within the scope of the invention. Not only can the process of this invention be used to remove metals as contaminants, it can be used as a collection or mining operation, particularly for rare or trace metals. The titanate sorbents, MST and APT, when loaded with metal ions may be dissolved in an acid to allow recovery of the described metals. When loaded with radioactive or undesirable metals the loaded sorbents are disposed according to safety and ecology laws and regulations governing the disposal of such metals.

Other liquids that may contain metal ions which may be removed by the process of this invention include alcohols such as ethanol, and gasolines, fuel, and lubricating oils.

Upon reading the foregoing disclosure, additional embodiments or variations may become apparent to those skilled in the art; however, the scope of the invention is limited only by the scope of the following claims:

We claim:

1. A method of treating metal-containing liquids comprising the steps of:
a) providing a liquid containing metal ions; said liquid having a pH level in the range of 2 to 14;
b) providing titanate sorbent;
c) adding said sorbent to said liquid and agitating the resultant mixture whereby the sorbent adsorbs the metal ions, and the sorbent becomes loaded with metal ions; and thereafter,
d) separating the loaded sorbent from the liquid.

2. A method of treating metal-containing liquids comprising the steps of:
a) providing a filter system comprising a filter membrane embedded with titanate sorbent particles, said sorbent being selected from the group consisting of MST, APT; and a mixture of MST and APT;
b) providing a liquid having a pH level in the range from about 2 to 14 with metal ions therein; and
c) passing said liquid through said membrane whereby the titanate sorbs metal ions from the liquid.

3. The method of claim 1 wherein in step c) the filter system comprises a column containing a bed of said titanate sorbent particles and in step d) the liquid is passed through the bed.

4. The method of claim 1 wherein the liquid is water and the metal is a contaminant selected from the group consisting of cadmium, mercury, gold, and nickel and other transition metals.

5. The method of claim 2 wherein the liquid is water and the metal is a contaminant selected from the group consisting of cadmium, mercury, nickel, and gold.

6. The method of claim 1 wherein the metal is an actinide or lanthanide.

7. The method of claim 1 wherein the metal is selected from the alkaline earth elements.

8. The method of claim 1 wherein the metal is strontium.

9. The method of claim 2 wherein the filter membrane comprises an inert matrix such as cellulose or organic polymer.

10. The method of claim 3 wherein the adsorbent particles are embedded in porous substrate of alumina.

11. The method of claim 3 wherein the adsorbent particles are spherical beads of hydrous titanium oxide.

12. The method of claim 1 wherein the liquid is selected from the group consisting of alcohols, gasoline, fuel and lubricating oils.

13. The method of claim 2 wherein the liquid is selected from the group consisting of alcohols, gasoline, fuel and lubricating oils.
